(19) United States
(12) Patent Application Publication
(10) Pub. No.: US 2026/0154674 A1
(43) Pub. Date: Jun. 4, 2026

(54) INTENT FORECASTING FOR TRANSACTIONS

(71) Applicant: American Express Travel Related Services Company, Inc., New York, NY (US)

(72) Inventors: Rince THOMAS, Goodyear, AZ (US); Mukesh Narayana Moorthy Pandari Bhai, Phoenix, AZ (US); Ariel COULSON, Tampa, FL (US); Arunav BHATTACHARYA, Phoenix, AZ (US); Avinash Reddy BOKKA, Phoenix, AZ (US)

(73) Assignee: American Express Travel Related Services Company, Inc., New York, NY (US)

(21) Appl. No.: 18/965,633

(22) Filed: Dec. 2, 2024

(51) Int. Cl. G06Q 20/36; G06N 20/00; G06Q 20/38; G06Q 20/40

(52) U.S. Cl. CPC G06Q 20/3674; G06N 20/00; G06Q 20/382; G06Q 20/389; G06Q 20/40145

(57) ABSTRACT

A user interface may display of an interactive element based on a security credential received from a user device attempting to access the user interface. The security credential may be used to identify a digital wallet and historical transaction information associated with a user of the user device. The interactive element of the user interface may display a recommended transaction based on a pattern of transactions determined from the historical transaction information and a status of the digital wallet. The recommended transaction may be executed based on an interaction with the interactive element.

### BACKGROUND

In the current global economy, traditional payment systems have become a significant hindrance to seamless and efficient financial transactions. With the rise of digitalization, there is an increasing demand for payment systems that are fast, secure, and cost-effective. Traditional transaction systems, such as online payment systems, banking facilities, and the like, often require users to enter or provide sensitive personal and/or financial information for each transaction, posing risks of data breaches and fraud. Traditional transaction systems lack a streamlined process for linking user-specific transaction intents with proper channels for executing transactions and therefore result in a cumbersome and time-consuming user experience. Traditional transaction systems are unable to ensure the security and privacy of the user data (e.g., identity data, financial data, etc,) while providing a user-friendly interface for managing transactions.

### BRIEF DESCRIPTION OF THE DRAWINGS

The accompanying drawings are incorporated herein and form a part of the specification.

FIG. 1 shows a block diagram of an example system for intent forecasting for transactions, according to some aspects of this disclosure.

FIG. 2 shows an example system for training an item analysis module, according to some aspects.

FIG. 3 shows a flowchart of an example training method for generating a machine learning classifier to classify intents used for a user interface to depict informational elements for selectable items, according to some aspects.

FIG. 4 shows a flowchart of an example method for intent forecasting for transactions, according to some aspects of this disclosure.

FIG. 5 shows an example computer system useful for implementing various aspects of this disclosure.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for intent forecasting for transactions.

According to some aspects of this disclosure, an application configured with a user device may collect transaction data including, but not limited to, transaction amounts, transaction date/time, transaction execution channels (e.g., payment methods, etc.), method, transaction categories, transaction frequency, transaction completion status, and the like. Transaction data may indicate both online transactions (e.g., transactions performed via a network, Internet, application, etc.) and offline transactions. Raw transaction data may be transformed into features suitable for machine learning analysis via state vectors of transaction attributes, transaction treatment eligibilities, transaction ranking models, and/or the like based on patterns of transaction observations for different user devices indicated by the transaction data. Transformation of the raw transaction data may include, but is not limited to, normalization of transaction amounts and/or extraction of time-based features. Weights may be assigned to features based on their predicted significance in determining transaction priority. Decision trees, random forests, gradient boosting machines, and/or the like may be used to learn from the weighted features and forecast transaction priorities. A list of transaction intents may be generated and ordered by priority based on trained machine-learning model predictions. The highest-ranked transaction intents may be displayed via a user interface. Interaction with an interactive element of the user interface may cause the execution of the highest-ranked transaction intents.

For example, a user interface may display an interactive element based on a security credential received from a user device attempting to access the user interface. The security credential may be used to identify a digital wallet and historical transaction information associated with a user of the user device. The interactive element of the user interface may display a recommended transaction based on a pattern of transactions determined from the historical transaction information and the status of the digital wallet. The recommended transaction may be executed based on an interaction with the interactive element.

As described herein, the system, apparatus, device, method, and/or computer program product embodiments, and/or combinations and sub-combinations thereof, for intent forecasting for transactions leverages advanced data transformation and machine learning techniques to offer personalized and predictive insights into transaction-related behavior, enhancing the efficiency and user experience of digital payment systems. As described herein, the system, apparatus, device, method, and/or computer program product embodiments, and/or combinations and sub-combinations thereof, for intent forecasting for transactions improve the technical fields of cloud computing, and digital commerce.

As described herein, intent forecasting for transactions improves technologies associated with payment processing and user interface functionality/design. For example, a user interface designed to identify and pre-populate transaction information to satisfy transaction intents reduces the likelihood of errors that can occur with manual data entry. This is especially beneficial in financial transactions where accuracy is critical and even minor mistakes can lead to significant issues such as transaction delays and or financial losses. With pre-populated data and fewer reduced user input, security risks associated with data entry and transmission are minimized and ensures that data integrity and confidentiality are maintained throughout a transaction process. By engaging transaction systems, third-party systems, and payment networks via a single interactive action, the user interface described herein facilitates an integrated and seamless transaction experience. A user interface, as described herein, that automatically interact with various backend systems to fetch historical transaction data, verify transaction availabilities, confirm user identity, and execute transactiions (e.g., process payments, etc.) ensures that a user stays within a single workflow, enhancing the ease of use and efficiency. These and other advantages are described herein.

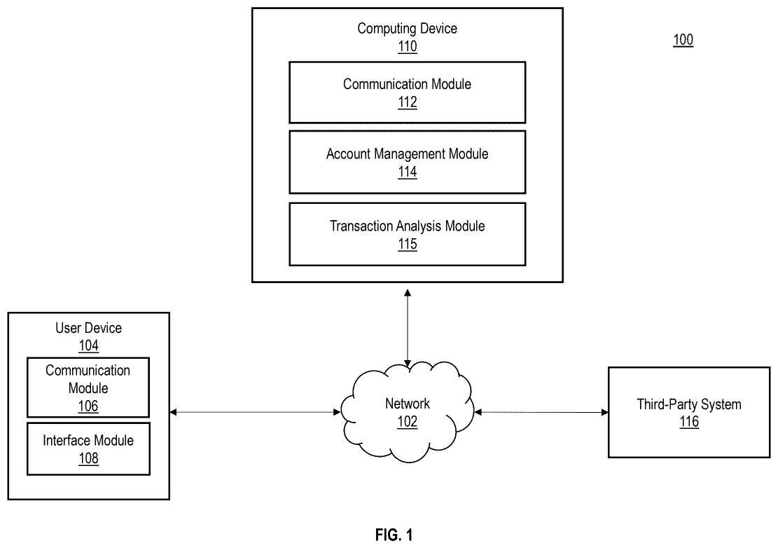

FIG. 1 shows an example system 100 for intent forecasting for transactions. System 100 is merely an example of one suitable system environment and is not intended to suggest any limitation as to the scope of use or functionality of aspects described herein. System 100 should not be interpreted as having any dependency or requirement related to any single module/component or combination of modules/components described therein.

According to some aspects of this disclosure, system 100 may include a network 102. Network 102 may include a packet-switched network (e.g., internet protocol-based network), a non-packet-switched network (e.g., quadrature amplitude modulation-based network), and/or the like. Network 102 may include network adapters, switches, routers, modems, and the like connected through wireless links (e.g., radiofrequency, satellite) and/or physical links (e.g., fiber optic cable, coaxial cable, Ethernet cable, or a combination thereof). Network 102 may include public networks, private networks, wide area networks (e.g., Internet), local area networks, and/or the like. Network 102 may include a payment network and/or may support/facilitate financial transactions. Network 102 may provide and/or support communication from a telephone, cellular phone, modem, and/or other electronic devices to and throughout the system 100. For example, system 100 may include and support communications between a user device 104, a computing device 110, and a third-party system 116 via network 102.

User device 104 may include a smart device, a mobile device, a computing device, and/or any other device capable of communicating with network 102 and/or device/components in communication with network 102. Although only a single user device 104 is shown, according to some aspects of this disclosure, system 100 may include any number of user devices 104.

User device 104 may include a communication module 106 that facilitates and/or enables communication with network 102 (e.g., devices, components, and/or systems of network 102, etc.), computing device 110, third-party system 116, and/or any other device/component of the system 100. For example, communication module 106 may include hardware and/or software to facilitate communication. Communication module 106 may comprise one or more of a modem, transceiver (e.g., wireless transceiver, etc.), digital-to-analog converter, analog-to-digital converter, encoder, decoder, modulator, demodulator, tuner (e.g., QAM tuner, QPSK tuner), and/or the like. Communication module 106 may include any hardware and/or software necessary to facilitate communication.

According to some aspects of this disclosure, user device 104 may include an interface module 108. Interface module 108 enables a user to interact with user device 104, network 102, computing device 110, third-party system 116, and/or any other device/component of system 100. Interface module 108 may include any interface for presenting and/or receiving information to/from a user. According to some aspects of this disclosure, interface module 108 may include a web browser, a mobile device application (e.g., AMEX PAY®, a payment application, etc.), and the like. Other software, hardware, and/or interfaces can be used to provide communication between user device 104, network 102, computing device 110, third-party system 116, and/or any other device/component of system 100. Interface module 108 may request/query and/or send/provide various files from a local source and/or a remote source, such as computing device 110, third-party system 116, and/or any other device/component of system 100.

According to some aspects of this disclosure, interface module 108 may include one or more input devices and/or components, for example, such as a keyboard, a pointing device (e.g., a computer mouse, remote control), a microphone, a joystick, a tactile input device (e.g., touch screen, gloves, etc.), and/or the like. According to some aspects of this disclosure, interaction with the input devices and/or components may enable a user to view, access, interact, request, and/or navigate a user interface generated, accessible, and/or displayed by interface module 108. According to some aspects of this disclosure, interaction with the input devices and/or components may enable a user to manipulate and/or interact with components of a user interface, for example, such as interactive elements, transaction facilitation tools, and/or the like.

User device 104 may include and/or be associated with a digital wallet. The digital wallet may include payment information and passwords associated with user device 104 (e.g., associated with a user of user device 104). For example, the digital wallet may include payment card information. The payment card may be associated with a primary account number (PAN). In some instances, the PAN may be tokenized for security. The PAN associated with user device 104 may be stored by a payment network (e.g., a payment network configured with, supported by, and/or enabled by network 102, etc.) in a database record linked to a payment account (and/or user profile) associated with a user (e.g., a user associated with and/or using user device 104, etc.). For example, a user device 104 (or user of user device 104) may be associated with a unique identifier that is linked to a digital wallet. The digital wallet may be linked and/or associated with different payment utilities and/or methods, for example, a payment account. The unique identifier may also link the digital wallet to a transaction service, such as a bill payment provider. The unique identifier may be used to authenticate and process payments from the digital wallet to a transaction service, such as a bill payment provider.

A payment account linked to a digital wallet may be maintained/controlled by a third-party system 116. For example, third-party system 116 may include and/or be part of a device/network associated with a financial institution that issues the payment account. According to some aspects of this disclosure, although not shown, system 100 may include multiple third-party systems 116. According to some aspects of this disclosure, the digital wallet may be associated with multiple payment cards that are each supported by one or more third-party systems 116.

According to some aspects of this disclosure, third-party systems 118 may include and/or support systems including, but not limited to, commercial entities (e.g., merchant devices, e-commerce platforms, etc.), financial institutions and/or finance-supporting institutions (e.g., banks, credit card companies, bill payment systems/services, etc.), and/or the like that interact with user device 104. Third-party systems 118 may include a system, compute infrastructure/architecture, and/or software platform configured to access a plurality of software applications, services, and/or data sources. Third-party systems 118 may include, facilitate, and/or support payment networks, blockchain, e-commerce, financial transactions, payment acceptance/remittance services, and/or the like. Data and/or information communicated between user device 104 and third-party system 118 may be collected and used to generate a transaction profile for user device 104 and/or a user of user device 104.

According to some aspects of this disclosure, user device 104 may generate and/or output data/information that may be used to build a transaction profile for user device 104 and/or a user of user device 104. For example, data indicative of the usage of different currencies, tools, or methods to perform online transactions including, but not limited to, bill payments, purchases, currency exchanges, and/or the like may be used to identify and/or infer transaction patterns. Additionally, location data output by and/or tracked by user device 104 may be used in conjunction with user input and/or preference details to indicate transactions made offline (e.g., transactions performed at brick-and-mortar transaction sites, check payments, bank drafts and money orders, direct deposit and bank transfers conducted using telephone-related technology, payments on delivery, etc.). Location data, user input, preference details, and/or the like may be used to identify and/or infer transaction patterns.

According to some aspects of this disclosure, data output by and/or tracked by user device 104 and/or third-party system 116 may be collected and/or provided to computing device 110. For example, computing device 110, user device 104, third-party system 118, and/or any other device/component of system 100 may be in communication and/or exchange information via a specially configured application (e.g., a transaction management application, a payment application, etc.).

According to some aspects of this disclosure, computing device 110 may include a server, a cloud-based compute resource, an entity-controlled device, or any other device capable of communicating with user device 104, third-party systems 116, and/or any other device/component of system 100, either described or (un)shown. Although shown as a single device, according to some aspects of this disclosure, computing device 110 may be part of a computing system and/or infrastructure, and/or may represent a plurality of computing devices. For example, computing device 110 may represent a plurality of computing devices in communication with user device 104, third-party systems 116, and/or any other device/component of system 100.

According to some aspects of this disclosure, computing device 110 may include communication module 112 that facilitates and/or enables communication with network 102 (e.g., devices, components, and/or systems of network 102, etc.), user device 104, third-party systems 116, and/or any other device/component of system 100. For example, communication module 112 may include hardware and/or software to facilitate communication. According to some aspects of this disclosure, communication module 112 may include one or more of a modem, transceiver (e.g., wireless transceiver, etc.), digital-to-analog converter, analog-to-digital converter, encoder, decoder, modulator, demodulator, tuner (e.g., QAM tuner, QPSK tuner), and/or the like. According to some aspects of this disclosure, communication module 112 may include any hardware and/or software necessary to facilitate communication.

According to some aspects of this disclosure, computing device 110 may include software and/or hardware that uses communication protocols including, but not limited to HTTP (Hypertext Transfer Protocol) and/or the like to respond to requests from user device 104. Computing device 124 may respond to requests from user device 104 with data/information needed to generate, render, and/or cause to be displayed an interactive element of a user interface, for example, overlaying a location/portion of the user interface.

For example, the computing device 110 may include and/or be configured with a representational state transfer (REST) API that facilitates interactions with RESTful services, such as interactive elements (e.g., pop-ups, selectable items, informational items, etc.) and/or the like. According to some aspects of this disclosure, displaying, rendering, and/or presenting interactive elements may be facilitated via a just-in-time compiled programming language such as JavaScript, Typescript, Dart, ClojureScript, Ruby, Python, and/or the like. Additionally, technology including JavaScript with dynamic generation of a Document Object Model (DOM), Cascading Style Sheets (CSS), jQuery, Asynchronous Javascript and XML (AJAX), and code libraries may be used to generate, render, and/or cause the display of one or more interactive elements within a user interface. According to some aspects of this disclosure, computing device 110 (and user device 114) may use any user interface interaction method to cause a user interface to display interactive elements.

Computing device 110 (and user device 114) may support one or more event listeners for a user interface that detects interaction with a displayed interactive element. For example, when a user of user device 104 uses an interactive component of the user device 104 to click and/or select an interactive element, the interaction may be detected and/or identified by a respective event listener. An interactive element may link to and/or be associated with one or more services/tools that facilitate the execution of transactions.

According to some aspects of this disclosure, computing device 110 may include an account management module 114. Account management module 114 may store information regarding user devices and/or users of user devices. Device identifiers may be mapped and/or associated with user identifiers and vice versa. Device identifers and user identiers may collectively or separately serve as security credentials. A device identifier may be used to identify a user identifier and/or a user account. The user identifier may also be used to identify a device identifier and/or related user account. Data/information mapping and/or associating identifiers (e.g., device identifiers, user identifiers, entity identifiers, security credentials, user account identifiers, etc.) may be stored, for example, via a lookup table, and/or the like. According to some aspects of this disclosure, security credentials may include biometrics, passwords, tokens, encrypted data, and/or the like.

According to some aspects of this disclosure, account management module 114 may store user accounts that include information that describes attributes associated with one or more users and/or user devices. User accounts may include information that indicates and/or describes demographic and/or demographic-related information, and/or the like. User accounts may include information that indicates and/or describes transaction services and/or transaction types preferred/disliked by users, describes transaction services and/or transaction types experienced by users, and/or the like. For example, a user account may include information that indicates and/or describes a particular payment channel (e.g., online payment, mail-in payment, onsite payment, etc.) and/or payment types (e.g., round-up payments, early payments, principal balance payments, medical payments, mortgage payments, etc.) preferred/disliked by users of user devices 104, and/or the like. User accounts may include information that indicates and/or describes any information that may be used to recommend transactions to user and/or user device.

User accounts may include information that indicates and/or describes payment account/balance information, budget and/or budgetary constraint information, financial and/or transaction history information, and/or the like. For example, a user account may include a transaction profile for user device 104 and/or a user of user device 104. A transaction profile may indicate transaction details including, but not limited to, transaction amounts, transaction dates/times, payment methods, transaction categories, transaction frequency, transaction completion status, and/or the like.

According to some aspects of this disclosure, computing device 110 may include a transaction analysis module 115. Transaction analysis module 115 may analyze transaction profiles and recommend transactions. For example, transaction analysis module 115 may include a machine learning model trained to find patterns within historical transaction information including, but not limited to, payment behavior of making payments. Transaction analysis module 115 may use patterns gleaned from transaction profiles to generate a ranked and/or prioritized list transactions, such as of payment intents and/or the like, that are preferred by a user device 104 and/or a user of user device 104. The ranked and/or prioritized list transactions may be used to pre-populate transaction information for a specific transaction indicated by a interactive element of a user interface so that the transaction may be executed responsive to interaction with the interactive element. For example, the ranked and/or prioritized list transactions may be used to enable a one-click user interface experience for resolving transactions that is more secure and expedited in comparison to conventional transaction methods and systems.

For example, transaction analysis module 115 may transform raw transaction data into features suitable for machine learning analysis, including, but not limited to. normalization of transaction amounts and extraction of time-based features. For example, in the case of a payment system, raw transaction data may include dates when certain payments are made to an entity or service by a user/user device 104, payment amounts, indications of a user (e.g., payee), payment methods, payment categories (e.g., utilities, mortgage, credit card, etc.). The raw transaction data may be transformed into meaningful features that reflect transaction attributes. For example, transformation may include normalization of transaction amounts, encoding categorical data, extracting time-based features, and/or the like. Transformation of the raw transaction data may include, but is not limited to, generation state vectors of transaction attributes, transaction treatment eligibilities, transaction ranking models, and/or the like.

According to some aspect of this disclosure, transaction analysis module 115 may generate vectors representing the state of each transaction indicated in raw transaction data based on transaction-specific attributes. For example, a vector might represent a transaction's amount relative to an average transaction amount for a user and/or user device 104, the time since the last transaction for a user and/or user device 104 occurred in the a same transaction category, and/or the like. State vectors may be used by transaction analysis module 115 to capture the context of each transaction in a numerical format that one or more machine learning models of transaction analysis module 115 may process.

According to some aspect of this disclosure, transaction analysis module 115 may generate transaction treatment eligibilities based on raw transaction data. Transaction analysis module 115 may identify transactions in a transaction profile that are eligible for certain treatments including, but not limited to, rewards, discounts, prioritization in payment processing, and/or the like. Transaction analysis module 115 may generate ranking values, scores, flags, and/or the like indicating transaction treatment eligibility based on predefined criteria. For example, transaction analysis module 115 may generate an indicator that transactions above a certain amount are eligible for cashback, a value reward, and/or the like.

According to some aspects of this disclosure, transaction analysis module 115 may assign ranking values to transactions indicated in a transaction profile based on certain criteria which may include, but are not limited to, urgency, importance, situational relevancy, and/or the like. Transaction analysis module 115 may assign weights to features based on their predicted significance in determining transaction type rankings such as bill payment priorities and/or the like. For example, transaction analysis module 115 may use historical data to identify which types of bills are typically paid first by a user, assign higher priority to transactions with upcoming due dates, and/or the like.

Features extracted, generated, and/or transformed from raw transaction data may be used to generate a data set that is used to train one or more machine learning models of transaction analysis module 115 to generate a list of transaction intents ordered by execution priority.

According to some aspects of this disclosure, an algorithm for transaction analysis module 115 to analyze transaction profiles and recommend transactions is provided in Algorithm 1 below as part of intent forecasting for transactions. Algorithm 1 uses transaction dates, transaction types/options, transaction instrument, and/or the like to determine a score for different combinations of transaction types/options and transaction instruments. Transactions with the highest scores may be used to forecast transaction intents. According to some aspects of this disclosure, Algorithm 1 also checks for additional parameters including, but not limited to, the transaction funding sources, temporal constraints (e.g., what time of the month a customer is making certain transactions, etc.). Any identified transaction patterns and/or transaction intents may be stored, for example, in a table and/or the like for future forecasting. According to some aspects, Algorithm 1 is just an example and other algorithms may be used to analyze transaction profiles and recommend transactions.

### Algorithm 1

Steps:
1. Order historical transactions based on timing information (e.g., transaction timestamps, schedules, etc.).
2. Apply transaction scores to each historical transaction in descending order based on the transaction date, transaction type/option, and transaction instrument.
3. Group historical transactions based on transaction type/option and transaction instrument to generate a grouping key.
4. Identify the number of occurrences of any grouping key.
5. Calculate a weighted transaction score by multiplying the number of occurrences of the grouping key by the transaction scores.
6. For ties in weighted transaction scores, the highest importance is given to the historical transactions with the most recent type/option and transaction instrument, and the weighted transaction scores are updated by 1.
7. For grouping keys greater than 1, before generating a transaction intent, determine if there are any attributes (e.g., date range, transaction channel, etc.) that have the similar number of occurrences of grouping key. If there are any, then add the attributes when generating a transaction intent.
8. Generate transaction intents for the highest transaction scores and trasactions with attributes.
9. Endfor.

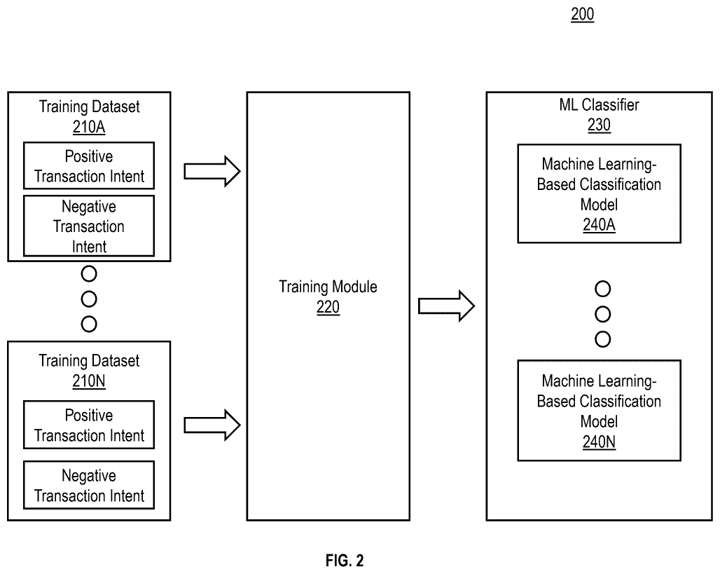

FIG. 2 is described with reference to FIG. 1. FIG. 2 is an example system 200 for training transaction analysis module 115 to identify transaction intents based on transaction patterns determined from and/or indicated by a transaction profile. According to some aspects of this disclosure, system 200 may use machine learning techniques to train at least one machine learning-based classifier 230 (e.g., a software model, neural network classification layer, etc.). The machine learning-based classifier 230 may be trained by the transaction analysis module 115 based on an analysis of one or more training datasets 210A-210N. The machine learning-based classifier 230 may be configured to classify features extracted from transaction data indicated by a user account (e.g., a transaction profile, etc.). features may include, but are not limited to, normalized transaction amounts (e.g., payment amounts may be scaled to handle a wide range in values), time-based features (e.g., day of the week, month, time of day, etc when transactions occur), features that capture historical transaction behavior (e.g., average transaction/payment amount in a category, frequency of transactions/payments in a time frame, transaction/payment channels and/or method used, etc.), and/or the like.

The one or more training datasets 210A-210N may comprise labeled baseline data such as labeled currency types, labeled payment channels (e.g., online payments, mail-in payments, etc.), labeled demographic information (e.g., data mapping selectable items and/or item types to demographic characteristics associated with various users—younger users like to pay a minimum balance, older user like to pay bills of the largest amounts before paying bills of smaller amounts, certain users enjoy prepayment options, etc.), and/or the like. The labeled baseline data may include any number of feature sets. Feature sets may include, but are not limited to, labeled data that identifies extracted features from transaction data, various data sources (e.g., third-party system 116 of FIG. 1,, etc.) describing transactions at various locations (e.g., bill payment sites, restaurants, merchant locations, etc.), and/or the like.

The labeled baseline data may be stored in one or more databases. Data for user interfaces to display interactive elements that associate various transactions and/or transaction channels may be randomly assigned to a training dataset or a testing dataset. According to some aspects of this disclosure, the assignment of data to a training dataset or a testing dataset may not be completely random. In this case, one or more criteria may be used during the assignment, such as ensuring that similar transaction intents, similar transaction channels, similar demographic and transaction type pairings, similar transaction patterns, similar behavioral patterns, dissimilar transaction intents, dissimilar transaction channels, dissimilar demographic and transaction type pairings, dissimilar transaction patterns, dissimilar behavioral patterns, and/or the like may be used in each of the training and testing datasets. In general, any suitable method may be used to assign the data to the training or testing datasets.

The transaction analysis module 115 may train the machine learning-based classifier 230 by extracting a feature set from the labeled baseline data according to one or more feature selection techniques. According to some aspects of this disclosure, the transaction analysis module 115 may further define the feature set obtained from the labeled baseline data by applying one or more feature selection techniques to the labeled baseline data in the one or more training datasets 210A-210N. The transaction analysis module 115 may extract a feature set from the training datasets 210A-210N in a variety of ways. The transaction analysis module 115 may perform feature extraction multiple times, each time using a different feature-extraction technique. In some instances, the feature sets generated using the different techniques may each be used to generate different machine learning-based classification models 240. According to some aspects of this disclosure, the feature set with the highest quality metrics may be selected for use in training. The transaction analysis module 115 may use the feature set(s) to build one or more machine learning-based classification models 240A-240N that are configured to determine and/or predict transaction intents, transaction channels, demographic and transaction type pairings, transaction patterns, transaction patterns, behavioral patterns, and/or the like.

According to some aspects of this disclosure, the training datasets 210A-210N and/or the labeled baseline data may be analyzed to determine any dependencies, associations, and/or correlations between transaction intents, transaction channels, demographic and transaction type pairings, transaction patterns, transaction patterns, behavioral patterns, and/or the like in the training datasets 210A-210N and/or the labeled baseline data. The term “feature,” as used herein, may refer to any characteristic of an item of data that may be used to determine whether the item of data falls within one or more specific categories. For example, the features described herein may comprise transaction intents, transaction channels, demographic and transaction type pairings, transaction patterns, transaction patterns, behavioral patterns, and/or the like.

According to some aspects of this disclosure, a feature selection technique may comprise one or more feature selection rules. The one or more feature selection rules may comprise determining which features in the labeled baseline data appear over a threshold number of times in the labeled baseline data and identifying those features that satisfy the threshold as candidate features. For example, any features that appear greater than or equal to 2 times the labeled baseline data may be considered candidate features. Any features appearing less than 2 times may be excluded from consideration as a feature.

According to some aspects of this disclosure, a single feature selection rule may be applied to select features or multiple feature selection rules may be applied to select features. According to some aspects of this disclosure, the feature selection rules may be applied in a cascading fashion, with the feature selection rules being applied in a specific order and applied to the results of the previous rule. For example, the feature selection rule may be applied to the labeled baseline data to generate information (e.g., recommended transactions, prioritized transactions, optimized tranasctions, etc.) that may be used for a user interface to associate with one or more interactive elements that facilitate execution of transactions. A final list of candidate features may be analyzed according to additional features.

According to some aspects of this disclosure, the transaction analysis module 115 may generate information (e.g., recommended transactions, prioritized transactions, optimized tranasctions, etc.) that may be used by a user interface to associate with one or more interactive elements that facilitate execution of transactions based on a wrapper method. A wrapper method may be configured to use a subset of features and train the machine learning model using the subset of features. Based on the inferences that are drawn from a previous model, features may be added and/or deleted from the subset. Wrapper methods include, for example, forward feature selection, backward feature elimination, recursive feature elimination, combinations thereof, and the like. According to some aspects of this disclosure, forward feature selection may be used to identify one or more candidate transaction intents, transaction channels, demographic and transaction type pairings, transaction patterns, transaction patterns, behavioral patterns, and/or the like. Forward feature selection is an iterative method that begins with no feature in the machine learning model. In each iteration, the feature that best improves the model is added until the addition of a new variable does not improve the performance of the machine learning model. According to some aspects of this disclosure, backward elimination may be used to identify one or more candidate transaction intents, transaction channels, demographic and transaction type pairings, transaction patterns, transaction patterns, behavioral patterns, and/or the like. Backward elimination is an iterative method that begins with all features in the machine learning model. In each iteration, the least significant feature is removed until no improvement is observed in the removal of features. According to some aspects of this disclosure, recursive feature elimination may be used to identify one or more candidate transaction intents, transaction channels, demographic and transaction type pairings, transaction patterns, transaction patterns, behavioral patterns, and/or the like. Recursive feature elimination is a greedy optimization algorithm that aims to find the best-performing feature subset. Recursive feature elimination repeatedly creates models and keeps aside the best or the worst-performing feature at each iteration. Recursive feature elimination constructs the next model with the features remaining until all the features are exhausted. Recursive feature elimination then ranks the features based on the order of their elimination.

According to some aspects of this disclosure, one or more candidate transaction intents, transaction channels, demographic and transaction type pairings, transaction patterns, transaction patterns, behavioral patterns, and/or the like may be determined according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to an absolute value of the magnitude of coefficients and ridge regression performs L2 regularization which adds a penalty equivalent to the square of the magnitude of coefficients.

After transaction analysis module 115 generates a feature set(s), the transaction analysis module 115 may generate a machine learning-based classification model 340 based on the feature set(s). A machine learning-based predictive model may refer to a complex mathematical model for data classification that is generated using machine-learning techniques. For example, this machine learning-based classifier may include a map of support vectors that represent boundary features. By way of example, boundary features may be selected from, and/or represent the highest-ranked features in, a feature set.

According to some aspects of this disclosure, the transaction analysis module 115 may use the feature sets extracted from the training datasets 210A-210N and/or the labeled baseline data to build a machine learning-based classification model 340A-340N to determine and/or predict transaction intents, transaction channels, demographic and transaction type pairings, transaction patterns, transaction patterns, behavioral patterns, and/or the like. According to some aspects of this disclosure, the machine learning-based classification models 340A-340N may be combined into a single machine learning-based classification model 340 (340A-340N). Similarly, the machine learning-based classifier 230 may represent a single classifier containing a single or a plurality of machine learning-based classification models 340 and/or multiple classifiers containing a single or a plurality of machine learning-based classification models 340. According to some aspects of this disclosure, the machine learning-based classifier 230 may also include each of the training datasets 210A-210N and/or each feature set extracted from the training datasets 210A-210N and/or extracted from the labeled baseline data. Although shown separately, transaction analysis module 115 may include the machine learning-based classifier 230.

The extracted features from the transaction data may be combined in a classification model trained using a machine learning approach such as discriminant analysis; a decision tree; a nearest neighbor (NN) algorithm (e.g., k-NN models, replicator NN models, etc.); a statistical algorithm (e.g., Bayesian networks, etc.); a clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; a principal component analysis (PCA) (e.g., for linear models); a multi-layer perceptron (MLP) ANNs (e.g., for non-linear models); replicating reservoir networks (e.g., for non-linear models, typically for time series); random forest classification; a combination thereof and/or the like. The resulting machine learning-based classifier 230 may comprise a decision rule or a mapping that uses transaction data to determine and/or predict transaction intents, transaction channels, demographic and transaction type pairings, transaction patterns, transaction patterns, behavioral patterns, and/or the like.

Transaction data and/or data from various sources (e.g., third-party system 116 of FIG. 1, online and cloud-based resources, social media, item review sites, etc.) describing transactions performed via various channels and/or at various locations, and the machine learning-based classifier 230 may be used to determine and/or predict transaction intents, transaction channels, demographic and transaction type pairings, transaction patterns, transaction patterns, behavioral patterns, and/or the like for the test samples in the test dataset. For example, the result for each test sample may include a confidence level that corresponds to a likelihood or a probability that the corresponding test sample accurately determines and/or predicts transaction intents, transaction channels, demographic and transaction type pairings, transaction patterns, transaction patterns, behavioral patterns, and/or the like. The confidence level may be a value between zero and one that represents a likelihood that the determined/predicted transaction intents, transaction channels, demographic and transaction type pairings, transaction patterns, transaction patterns, behavioral patterns, and/or the like are consistent with computed values. Multiple confidence levels may be provided for each test sample and each candidate (approximated) transaction intents, transaction channels, demographic and transaction type pairings, transaction patterns, transaction patterns, behavioral patterns, and/or the like. A top-performing candidate transaction intents, transaction channels, demographic and transaction type pairings, transaction patterns, transaction patterns, behavioral patterns, and/or the like may be determined by comparing the results obtained for each test sample with computed transaction intents, transaction channels, demographic and transaction type pairings, transaction patterns, transaction patterns, behavioral patterns, and/or the like for each test sample. In general, the top-performing candidate transaction intents, transaction channels, demographic and transaction type pairings, transaction patterns, transaction patterns, behavioral patterns, and/or the like will have results that closely match the computed transaction intents, transaction channels, demographic and transaction type pairings, transaction patterns, transaction patterns, behavioral patterns, and/or the like. The top-performing candidate transaction intents, transaction channels, demographic and transaction type pairings, transaction patterns, transaction patterns, behavioral patterns, and/or the like may be used by a user interface to associate with one or more interactive elements that facilitate the execution of transactions and/or related operations.

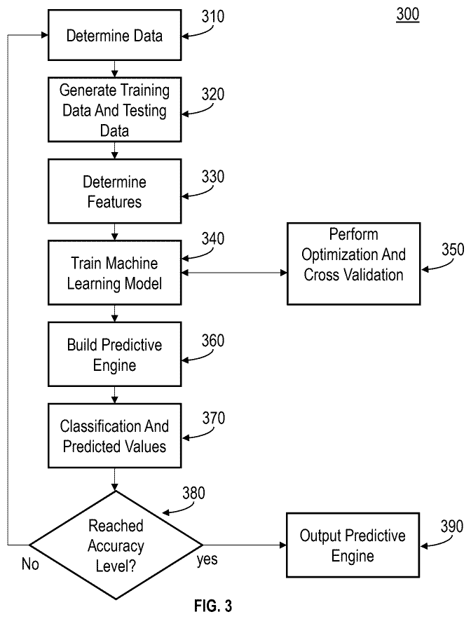

FIG. 3 is a flowchart illustrating an example training method 300. According to some aspects of this disclosure, method 300 configures machine learning classifier 230 for classification through a training process using the transaction analysis module 115. The transaction analysis module 115 can implement supervised, unsupervised, and/or semi-supervised (e.g., reinforcement-based) machine learning-based classification models 240. Method 300 shown in FIG. 3 is an example of a supervised learning method; variations of this example of training method are discussed below, however, other training methods can be analogously implemented to train unsupervised and/or semi-supervised machine learning (predictive) models. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

Method 300 shall be described with reference to FIGS. 1-2. However, method 300 is not limited to the aspects of those figures.

In 310, the transaction analysis module 115 determines, receives, and/or the like, transaction data from one or more transaction profiles. Transaction data and/or other data from various sources may be used to generate one or more datasets, each dataset associated with transaction intents, transaction channels, demographic and transaction type pairings, transaction patterns, transaction patterns, behavioral patterns, and/or the like.

In 320, transaction analysis module 115 generates a training dataset and a testing dataset. According to some aspects of this disclosure, the training dataset and the testing dataset may be generated by indicating transaction intents, transaction channels, demographic and transaction type pairings, transaction patterns, transaction patterns, behavioral patterns, and/or the like. According to some aspects of this disclosure, the training dataset and the testing dataset may be generated by randomly assigning an transaction intents, transaction channels, demographic and transaction type pairings, transaction patterns, transaction patterns, behavioral patterns, and/or the like to either the training dataset or the testing dataset. According to some aspects of this disclosure, the assignment of transaction data and/or data from various sources as training or test samples may not be completely random. According to some aspects of this disclosure, only the labeled baseline data for a specific feature extracted from specific transaction data and/or specific data from various sources (e.g., data indicating a preferable transaction channel, payment type, payment amount, transaction type/amount, etc.) may be used to generate the training dataset and the testing dataset. According to some aspects of this disclosure, a majority of the labeled baseline data extracted from transaction data and/or data from various sources may be used to generate the training dataset. For example, 75% of the labeled baseline data for determining an transaction intents, transaction channels, demographic and transaction type pairings, transaction patterns, transaction patterns, behavioral patterns, and/or the like extracted from the transaction data may be used to generate the training dataset and 25% may be used to generate the testing dataset. Any method or technique may be used to create the training and testing datasets.

In 330, transaction analysis module 115 determines (e.g., extract, select, etc.) one or more features that can be used by, for example, a classifier (e.g., a software model, a classification layer of a neural network, etc.) to label features extracted from a variety of transaction data and/or data from various sources. One or more features may comprise indications of transaction intents, transaction channels, demographic and transaction type pairings, transaction patterns, transaction patterns, behavioral patterns, and/or the like.

According to some aspects of this disclosure, the transaction analysis module 115 may determine a set of training baseline features from the training dataset. Features of transaction data may be determined by any method.

In 340, transaction analysis module 115 trains one or more machine learning models, for example, using one or more features. According to some aspects of this disclosure, the machine learning models may be trained using supervised learning.

According to some aspects of this disclosure, other machine learning techniques may be employed, including unsupervised and semi-supervised learning. The machine learning models trained in 340 may be selected based on different criteria (e.g., how close a predicted transaction intents, transaction channels, demographic and transaction type pairings, transaction patterns, transaction patterns, behavioral patterns, and/or the like is to an actual transaction intents, transaction channels, demographic and transaction type pairings, transaction patterns, transaction patterns, behavioral patterns, and/or the like, etc.) and/or data available in the training dataset. For example, machine learning classifiers can suffer from different degrees of bias. According to some aspects of this disclosure, more than one machine learning model can be trained.

In 350, transaction analysis module 115 optimizes, improves, and/or cross-validates trained machine learning models. For example, data for training datasets and/or testing datasets may be updated and/or revised to include more labeled data indicating different transaction intents, transaction channels, demographic and transaction type pairings, transaction patterns, transaction patterns, behavioral patterns, and/or the like.

In 360, transaction analysis module 115 selects one or more machine-learning models to build a machine-learning model (e.g., a machine-learning classifier, a predictive engine, etc.). The machine-learning model may be evaluated using the testing dataset.

In 370, transaction analysis module 115 executes the machine-learning model to analyze the testing dataset and generate classification values and/or predicted values.

In 380, transaction analysis module 115 evaluates classification values and/or predicted values output by the machine-learning model to determine whether such values have achieved the desired accuracy level. The performance of the machine-learning model may be evaluated in several ways based on a number of true positive, false positive, true negative, and/or false negative classifications of the plurality of data points indicated by the machine-learning model. For example, the false positives of the machine-learning model may refer to the number of times the machine-learning model incorrectly predicted and/or determined transaction intents, transaction channels, demographic and transaction type pairings, transaction patterns, transaction patterns, behavioral patterns, and/or the like. Conversely, the false negatives of the machine-learning model may refer to the number of times the machine-learning model predicted and/or determined transaction intents, transaction channels, demographic and transaction type pairings, transaction patterns, transaction patterns, behavioral patterns, and/or the like incorrectly, when in fact, the predicted and/or determined transaction intents, transaction channels, demographic and transaction type pairings, transaction patterns, transaction patterns, behavioral patterns, and/or the like matches actual transaction intents, transaction channels, demographic and transaction type pairings, transaction patterns, transaction patterns, behavioral patterns, and/or the like. True negatives and true positives may refer to the number of times the machine-learning model correctly predicted and/or determined transaction intents, transaction channels, demographic and transaction type pairings, transaction patterns, transaction patterns, behavioral patterns, and/or the like. Related to these measurements are the concepts of recall and precision. Generally, recall refers to a ratio of true positives to a sum of true positives and false negatives, which quantifies the sensitivity of the machine-learning model. Similarly, precision refers to a ratio of true positives as a sum of true and false positives.

In 390, transaction analysis module 115 outputs the machine-learning model (and/or an output of the machine-learning model). For example, transaction analysis module 115 may output the machine-learning model when such a desired accuracy level is reached. An output of the machine-learning model may end the training phase.

According to some aspects of this disclosure, when the desired accuracy level is not reached, in 390, transaction analysis module 115 may perform a subsequent iteration of the training method 300 starting at 310 with variations such as, for example, considering a larger collection of transaction data and/or data from various sources (e.g., third-party system 116 of FIG. 1.).

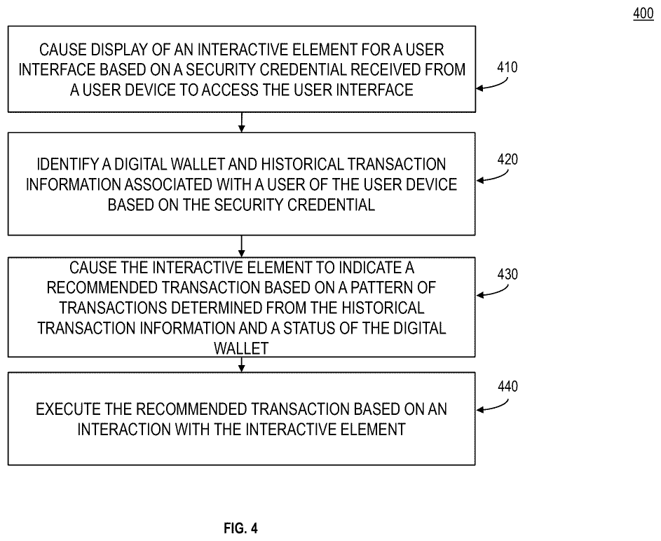

FIG. 4 shows a flowchart of an example method 400 for intent forecasting for transactions, according to some aspects of this disclosure. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art. Method 400 shall be described with reference to FIGS. 1-3. However, method 400 is not limited to the aspects of those figures.

In 402, computing device 110 causes a user interface displayed by a user device (e.g., user device 104) to display an interactive element based on a security credential received from the user device to access the user interface. For example, the user device may be specially configured with a transaction application that facilitates communication between the user device and computing device 110. Computing device may send an instruction, via the application, that causes the user interface to display the interactive element.

According to some aspects of this disclosure, to enable the security of information communicated between the user device and computing device 110 and to prevent fraud, the security credential may include biometric information (e.g., fingerprint, image data, voice print, retinal scan information, etc.) associated with a user of the user device. According to some aspects, the security credential may include passwords, access tokens, personal identification numbers, digital certificates, and/or multi-factor authentication information.

In 404, computing device 110 identifies a digital wallet and historical transaction information associated with a user of the user device based on the security credential. For example, computing device 110 may use the security credential to authenticate and authorize the user device to display the interactive element, and map (e.g., via a lookup table, etc.) the security credential to the digital wallet and a user account (e.g., a transaction profile, etc.) that indicates the historical transaction information. The historical transaction information may indicate both online transactions and offline transactions.

In 406, computing device 110 causes the interactive element to indicate a recommended transaction. The recommended transaction may indicate a transaction type, a transaction amount, a transaction date, a transacting entity, a transaction frequency, a transaction channel, and/or the like. According to some aspects of this disclosure, computing device 110 causes the interactive element to indicate a recommended transaction(s) based on a pattern of transactions determined from the historical transaction information and the status of the digital wallet.

For example, the recommended transaction may be displayed along with a prioritized list of transactions (e.g., payment intents) that are preferred by the user device and/or a user of the user device. The recommended transaction may be a transaction associated with a transaction amount that is satisfied by the status of the digital wallet. For example, computing device 110 may recommend a payment transaction for a bill of a certain amount if the status of the digital wallet indicates that funds of at least a certain amount are available within an account associated with the digital wallet. Computing device 110 may avoid recommending a payment transaction for a bill of a certain amount if the status of the digital wallet indicates that funds of less than a certain amount are available within an account associated with the digital wallet.

According to some aspects of this disclosure, the historical transaction information may indicate online transactions and offline transactions. In an embodiment, the recommended transaction may be an online transaction if an amount of historical online transactions indicated by the historical transaction information satisfies a transaction threshold. In an embodiment, the recommended transaction may be an offline transaction if an amount of historical offline transactions indicated by the historical transaction information satisfies the transaction threshold.

According to some aspects of this disclosure, computing device 110 may receive the recommended transaction from a machine-learning model that has been trained to generate the recommended transaction based on attributes of the historical transaction information. For example, in the context of bill payment transactions, the machine-learning model may perform a weighted algorithm on attributes of to the historical transaction information to identify a pattern of making payments within payment behavior.

Training the predictive model may include extracting transaction data from a user device-specific dataset. State vectors of transaction attributes, transaction treatment eligibilities, and/or transaction ranking models may be generated for the transaction data based on patterns of transactions observations for different user devices indicated by the transaction data. A training dataset may be generated based on the transaction data and the state vectors of transaction attributes, the transaction treatment eligibilities, and/or the transaction ranking models. The training data set may be used to train the machine-learning model to generate recommended transactions based on patterns of transactions determined from the transaction data. The performance of the machine-learning model may be validated by validating an output of the machine-learning model using a validating dataset generated based on the transaction data. The validated machine-learning model may be calibrated to generate the recommended transaction based on the validated output of the machine-learning model.

In 406, computing device 110 executes the recommended transaction. Computing device 110 may execute and/or facilitate the execution of the recommended transaction based on an interaction with the interactive element. For example, a selection of the recommended transaction may be used to pre-populate transaction information and facilitate execution of the recommended transaction (e.g., facilitate a one-Click submission experience, etc.) by engaging any transaction systems, third-party systems, payment accounts, payment networks, transaction services, and/or the like associated with the recommended transaction. For example, execution of the recommended transaction may include causing an amount of currency to be transferred from the digital wallet to an account associated with a transacting entity indicated by the recommended transaction.

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506. In some embodiments, processor 504 may include an encryption system. This may be used to provide transaction security and/or to pass secure and/or trusted data. In some embodiments, the encryption system may be a physical secure element chip. The encryption system may also use a kernel and/or other certified software element to provide encryption and/or decryption of communications and/or messages. Such functionality may be implemented using one or more processors, such as processor 504.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

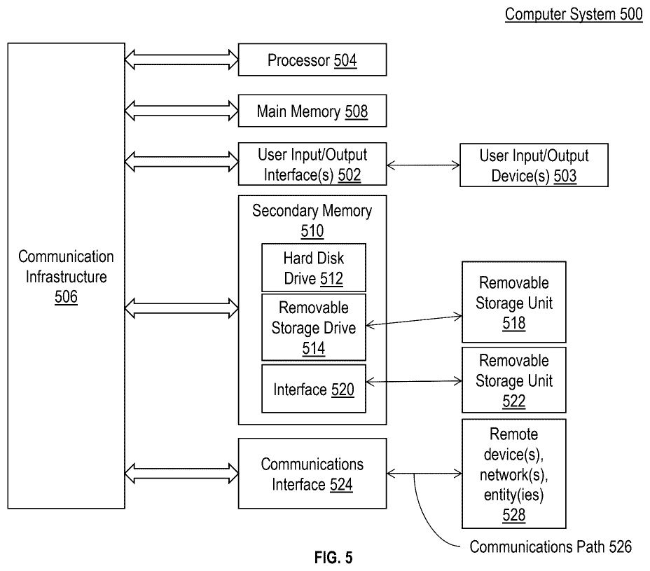

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A computer-implemented method comprising:
training, by at least one computer processor, a machine learning model to generate a recommended transaction based on a pattern of transactions, wherein the training comprises using a recursive feature elimination process to determine a best performing feature set of the pattern of transactions to be used to identify transaction intents from which the recommended transaction is chosen;
causing display of an interactive element for a user interface based on a security credential received from a user device to access the user interface;
identifying a digital wallet and historical transaction information associated with a user of the user device based on the security credential;
causing the interactive element to indicate the recommended transaction for the user based on the historical transaction information and a status of the digital wallet; and
executing the recommended transaction based on an interaction with the interactive element.

2. The computer-implemented method of claim 1, further comprising training the machine learning model based on:
extracting transaction data from a user device-specific dataset;
generating, for the transaction data, at least one of: state vectors of transaction attributes, transaction treatment eligibilities, or transaction ranking models based on the pattern of transactions observations for different user devices indicated by the transaction data;
generating a training dataset based on the transaction data and, and at least one of the state vectors of transaction attributes, the transaction treatment eligibilities, or the transaction ranking models;
training, using the training dataset, the machine-learning model to generate recommended transactions based on the pattern of transactions determined from the transaction data; and
validating an output of the machine-learning model using a validating dataset generated based on the transaction data.

3. The computer-implemented method of claim 1, wherein the security credential comprises biometric information.

4. The computer-implemented method of claim 1, wherein the historical transaction information indicates online transactions and offline transactions, wherein the recommended transaction is an online transaction if an amount of historical online transactions indicated by the historical transaction information satisfies a transaction threshold, and wherein the recommended transaction is an offline transaction if an amount of historical offline transactions indicated by the historical transaction information satisfies the transaction threshold.

5. The computer-implemented method of claim 1, wherein the recommended transaction indicates at least one of a transaction type, a transaction amount, a transaction date, a transaction frequency, or a transacting entity.

6. The computer-implemented method of claim 1, further comprising causing the interactive element to indicate another recommended transaction based on a change in the status of the digital wallet.

7. The computer-implemented method of claim 1, wherein the executing the recommended transaction comprises causing an amount of currency to be transferred from the digital wallet to an account associated with a transacting entity indicated by the recommended transaction.

8. A system, comprising:
a memory; and
at least one processor coupled to the memory and configured to:
train a machine learning model to generate a recommended transaction based on a pattern of transactions, wherein the training comprises using a recursive feature elimination process to determine a best performing feature set of the pattern of transactions to be used to identify transaction intents from which the recommended transaction is chosen;
cause display of an interactive element for a user interface based on a security credential received from a user device to access the user interface;
identify a digital wallet and historical transaction information associated with a user of the user device based on the security credential;
cause the interactive element to indicate the recommended transaction for the user based on a the historical transaction information and a status of the digital wallet; and
execute the recommended transaction based on an interaction with the interactive element.

9. The system of claim 8, wherein the at least one processors are further configured to train the machine learning model based on:
extracting transaction data from a user device-specific dataset;
generating, for the transaction data, at least one of: state vectors of transaction attributes, transaction treatment eligibilities, or transaction ranking models based on the pattern of transactions observations for different user devices indicated by the transaction data;
generating a training dataset based on the transaction data and, and at least one of the state vectors of transaction attributes, the transaction treatment eligibilities, or the transaction ranking models;
training, using the training dataset, the machine-learning model to generate recommended transactions based on the pattern of transactions determined from the transaction data; and
validating an output of the machine-learning model using a validating dataset generated based on the transaction data.

10. The system of claim 8, wherein the security credential comprises biometric information.

11. The system of claim 8, wherein the historical transaction information indicates online transactions and offline transactions, wherein the recommended transaction is an online transaction if an amount of historical online transactions indicated by the historical transaction information satisfies a transaction threshold, and wherein the recommended transaction is an offline transaction if an amount of historical offline transactions indicated by the historical transaction information satisfies the transaction threshold.

12. The system of claim 8, wherein the recommended transaction indicates at least one of a transaction type, a transaction amount, a transaction date, a transaction frequency, or a transacting entity.

13. The system of claim 8, wherein the at least one processors are further configured to cause the interactive element to indicate another recommended transaction based on a change in the status of the digital wallet.

14. The system of claim 8, wherein the executing the recommended transaction comprises causing an amount of currency to be transferred from the digital wallet to an account associated with a transacting entity indicated by the recommended transaction.

15. A non-transitory computer-readable medium having instructions stored thereon that, when executed by at least one computing device, causes the at least one computing device to perform operations comprising:
training a machine learning model to generate a recommended transaction based on a pattern of transactions, wherein the training comprises using a recursive feature elimination process to determine a best performing feature set of the pattern of transactions to be used to identify transaction intents from which the recommended transaction is chosen;
causing display of an interactive element for a user interface based on a security credential received from a user device to access the user interface;
identifying a digital wallet and historical transaction information associated with a user of the user device based on the security credential;
causing the interactive element to indicate the recommended transaction for the user based on the historical transaction information and a status of the digital wallet; and
executing the recommended transaction based on an interaction with the interactive element.

16. The non-transitory computer-readable medium of claim 15, wherein the operations further comprise training the machine learning model based on
extracting transaction data from a user device-specific dataset;
generating, for the transaction data, at least one of: state vectors of transaction attributes, transaction treatment eligibilities, or transaction ranking models based on the pattern of transactions observations for different user devices indicated by the transaction data;
generating a training dataset based on the transaction data and, and at least one of the state vectors of transaction attributes, the transaction treatment eligibilities, or the transaction ranking models;
training, using the training dataset, the machine-learning model to generate recommended transactions based on patterns of transactions determined from the transaction data; and
validating an output of the machine-learning model using a validating dataset generated based on the transaction data.

17. The non-transitory computer-readable medium of claim 15, wherein the security credential comprises biometric information.

18. The non-transitory computer-readable medium of claim 15, wherein the historical transaction information indicates online transactions and offline transactions, wherein the recommended transaction is an online transaction if an amount of historical online transactions indicated by the historical transaction information satisfies a transaction threshold, and wherein the recommended transaction is an offline transaction if an amount of historical offline transactions indicated by the historical transaction information satisfies the transaction threshold.

19. The non-transitory computer-readable medium of claim 15, wherein the recommended transaction indicates at least one of a transaction type, a transaction amount, a transaction date, a transaction frequency, or a transacting entity.

20. The non-transitory computer-readable medium of claim 15, wherein the executing the recommended transaction comprises causing an amount of currency to be transferred from the digital wallet to an account associated with a transacting entity indicated by the recommended transaction.
